(19) United States
(12) Patent Application Publication
(10) Pub. No.: US 2010/0104105 A1
(43) Pub. Date: Apr. 29, 2010

(54) DIGITAL CINEMA ASSET MANAGEMENT SYSTEM

(75) Inventors: Thomas J. Schmidt, Bloomington, MN (US); Scott Emberley, Eden Prairie, MN (US); John Bogrand, Minneapolis, MN (US)

Correspondence Address: HOGAN & HARTSON LLP, ONE TABOR CENTER, SUITE 1500, 1200 SEVENTEENTH ST, DENVER, CO, 80202, US

(73) Assignee: Digital Cinema Implementation Partners, LLC, Upper Saddle River, NJ (US)

(21) Appl. No.: 12/257,324

(22) Filed: Oct. 23, 2008

(51) Int. Cl. H04L 9/08; G06F 7/06; G06F 17/30; G06F 15/16

(52) U.S. Cl. 380/283; 709/201; 709/202; 707/E17.014

(57) ABSTRACT

A repository is created and maintained that receives and stores a plurality of attributes associated with digital components resident at a display complex and associated with particular digital cinema systems within that display complex. These attributes can be accessed by clients which thereafter use that data to securely convey digital content to a particular digital cinema system. Each display complex collects attributes associated with the digital cinema systems resident at the complex and pushes the data to a service module hosted on a server on a wide area network. Upon receiving the attributes corresponding to each digital component of each cinema system, the server conveys the data to a repository for storage. Thereafter, responsive to a request from a client, data needed to securely convey content to a digital cinema system is retrieved from the repository and conveyed to the requesting client.

### BACKGROUND OF THE INVENTION

1. Field of the Invention

Embodiments of the present invention relate, in general, to digital media and particularly to systems and methods for managing assets involved in the distribution and display of digital cinema media.

2. Relevant Background

The technology and business of theatrical film distribution and exhibition has been largely unchanged over the last 50 years. Traditionally, motion pictures have been physically distributed on film and shown in movie houses around the world with film projectors. However, movies now can be digitized and exhibited on digital projectors. While systems used in the preparation of film content for theatrical distribution and exhibition have become increasingly digital and computerized, the actual deliverables and image playback systems for movies have remained largely analog and mechanical. And, new projectors have the ability to project high-resolution imagery to a screen over 100 feet away greatly enhancing the viewing experience. There are many advantages with digital cinema, but along with these improvements come a number of challenges.

The distribution of digital media to a cinema can take place either electronically or physically. In a physical model, the transportation of the movies would not be unlike the current system. Rather than transporting reels of 35 mm film, the delivery would be of digital content stored on a physical media such as magnetic disc, flash drive, or the like. And, as with the current model, the physical distribution of digital movies carries with it the problems associated with conventional film distribution including time delay, reliability of the media, and security of the media in transit.

Electronic delivery resolves many of these issues but presents several managerial challenges. Several approaches have attempted to ensure the secure delivery of digital media. One technique is watermarking. Watermarking is a technique for representing metadata in a digital product by modifying the pixel values or audio samples of a movie. The changes can be imperceptible to the viewer or be substantial so as to prevent the viewer from enjoying a playback experience without first removing the watermark from the content.

Digital rights management (“DRM”) tools are also employed to secure digital cinema content. DRM technologies or tools encrypt an object and only allow decryption when a set of rules has been satisfied. The rules may relate to proof of payment, user authorization, authentication of a presenting device, and the like. Rules specify the actions that are permitted such as decryption, copying, editing, etc. as well as the people and/or organizations that can perform those actions. These rules are expressed in a rights management language. A typical DRM infrastructure includes the ability to interpret the rules, gather enough information to determine if the rules are satisfied, arrange for payment, obtain authorizations from a third party, and obtain decryption keys when necessary.

Encryption is also widely utilized with the distribution of digital cinema content. En route to the theater a digital movie is vulnerable to theft; to reduce that risk movies are encrypted. In order to make use of the move, a thief must also know the key to decipher the movie or try to decipher the movie without the key. There is sufficient encryption technology to prevent a would be thief from deciphering a stolen movie; however, with such a capability comes the challenge of key management.

Encryption generally involves two keys, a public key and a private key. A public key, normally hard coded in silicon in a device, is provided freely and is used to encrypt content that can only be decrypted using the private key maintained in the device. In one model of encryption a public key is used to encrypt a newly created private key generated by the source of the content. That source generated private key is then used to encrypt the content. The key to decrypt the content is sent to the holder of the public key in an encrypted state. Thus when the holder receives the encrypted key it can be decrypted to gain the source private key used to encrypt the digital content that will be arriving in a separate transmission. By separating the keys from the content an additional layer of security is placed on the content.

In the past communication of these keys has been via e-mail, telephone calls, or a spreadsheet that includes serial numbers of components associated with publicly available keys. In the context of digital cinema media, these communications would take place between a studio or a film distributor and a theater having one or more auditoriums. To obtain serial numbers the parties would contact the manufacturer of the hardware component to gain the public key. While this process is feasible when the number of theaters is small, it is not scalable. This is especially true when a module in a server maintains the public certificate. It is possible in such a situation to mismatch the certificates and serial numbers such that even the manufacturer fails to know the true public key of a device.

An additional challenge to distribution of encrypted digital cinema media is timely response to equipment changes. As mentioned, each component possesses its own private/public key pair. When any component, such as a projector, is replaced for any of a variety of reasons, a new set of keys must be conveyed to the distributor of the content. To do so in a timely manner is extremely difficult. A challenge therefore exists to manage public certificates and keys in an efficient and timely manner so as to facilitate large scale distribution of digital cinema media content and keys from a plurality of sources to a plurality of auditoriums.

### SUMMARY OF THE INVENTION

The digital asset management system and associated processes of the present invention offer significant improvements to achieve a robust and scalable database or repository of digital component attributes thereby enhancing the ability to efficiently deliver and display digital content throughout a plurality of digital auditoriums maintained within a plurality of display complexes.

In accordance with this general concept, a repository is created and maintained that receives and stores a plurality of attributes associated with digital components resident at a display complex and associated with particular digital auditoriums within that display complex. These attributes can be accessed by clients which thereafter use that data to securely convey digital content to a particular digital auditorium. Each display complex (also herein referred to as theaters) collects attributes associated with the digital auditoriums resident at the complex and pushes them to a service module hosted on a server on a wide area network. Upon receiving the attributes corresponding to each digital component of each auditorium, the server conveys the data to a repository for storage. Thereafter, responsive to a request from a client, data needed to securely convey content to a digital auditorium is retrieved from the repository and conveyed to the requesting client.

A repository is maintained storing attributes from a plurality of digital components. In accordance with one embodiment of the present invention, digital component attributes are associated with a particular digital component resident at a particular display complex. As data is received at the server, it is conveyed to a repository. Data is periodically received at the repository from each of the plurality of display complexes. Prior to the data being entered into the repository, a comparison is conducted to determine whether information associated with a particular digital component at a particular display complex has been altered. When it is determined that such a modification or change has occurred, a message signaling the change is pushed out and the repository is updated with the new information. In addition, and according to one embodiment of the present invention, a record of changes is created as well as an archived copy of the repository prior to the change. Should it be determined that the change occurred without authorization or was in error, the repository can revert to its previous state with minimal disruption of data flow.

The repository, according to one embodiment of the present invention, is continually updated by data received from a plurality of display complexes. Data gained by a server on a wide area network such as the Internet is pushed to the repository upon being received by the service module. The repository does not query the display complexes or the digital auditoriums for data. Information maintained in the repository includes digital component type, serial number, maintenance records, location, associated components, digital certificate, and public key.

In accordance with one aspect of the present invention, clients of the system can access data maintained within the repository. A request from a client for data can be received by the system, and upon authentication of the client's identity and its authority to access the data, the request can be passed to the repository for retrieval. An authorized request from an authenticated client results in the repository returning to the client a public certificate for a particular digital component. Using this public certificate the client can securely convey digital content to a specific digital component located at a specific display complex.

The processes described herein are preferably implemented by a computer or similar device capable of processing instructions written in code. Accordingly the methodology can be stored on a computer-readable medium in the form of one or more program codes that, when taken as a whole, instruct a server to receive from a plurality of display complexes digital component attributes resident at those complexes. The computer-readable storage media can also contain program codes having instructions to store the component attributes in a repository wherein the data is associated with a particular digital component auditorium at a specific display complex.

As new information is received from the server, program codes can direct the repository to compare the new entries with existing data and to generate a signal directed toward a user or system administrator that a change in a digital component attribute has occurred. Additional program codes can be written and stored on a computer-readable medium for receiving digital component attribute requests from one or more clients. A client can access the service module hosted on a server, and once the request has been authenticated as being placed by an authorized client with the appropriate authority, the service module can execute program codes to communicate with the repository and retrieve the desired information. Responsive to the information being accessed, program codes can thereafter instruct the service module to communicate it to the requesting client.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 shows a high level block diagram of a network environment including components in which one embodiment of an asset management system can be implemented according to the present invention;

FIG. 2 shows a high level data flow block diagram illustrating general flow of data between components of one embodiment of an asset management system; and

FIG. 3 is a high-level flowchart of one method embodiment for the management of digital component attributes, according to the present invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### GLOSSARY AND ACRONYMS

As a convenience in describing the invention herein, the following glossary of terms is provided. Because of the introductory and summary nature of this glossary, these terms must also be interpreted more precisely by the context of the Detailed Description in which they are discussed.

An Attribute is a characteristic or property of an entity. In the context of the present invention a component attribute can include the component's serial number, product type, installation date, manufacturer, public certificate, public key, location or any other characteristic or property that can be associated with that particular component.

An Auditorium is a room or location in which a gathering can take place. In the context of cinemas an auditorium is the location within a theater complex in which the movie is displayed for viewing by a group of people. An auditorium can also be a location for a private gathering of only a single occupant. A display complex (theater) may have one or more auditoriums.

Digital component(s) are the devices that enable digital content to be transformed from code to a screen presentation. In some instances a single digital component can receive, decrypt, convert the code to images, and project those images on a screen. In other instances many separate components are required to accomplish the same goal. While a digital projector is certainly a digital component, other components used to facilitate the projector's operation may also be considered digital components.

A Display Complex (also referred to herein as a theater) is a location housing one or more auditoriums.

HTML (HyperText Markup Language) is a markup language that is used to create documents on the World Wide Web incorporating text, graphics, sound, video, and hyperlinks. HTML provides a means to describe the structure of text-based information in a document by denoting certain text as links, headings, paragraphs, lists, and the like and to supplement that text with interactive forms, embedded images, and other objects.

HTTP (HyperText Transfer Protocol) is a communications protocol for the transfer of information on the Internet. HTTP is a request/response standard between a client and a server. A client is the end-user, the server is the web site. The client making an HTTP request—using a web browser, spider, or other end-user tool—is referred to as the user agent. The responding server—which stores or creates resources such as HTML files and images—is called the origin server. In between the user agent and origin server may be several intermediaries, such as proxies, gateways, and tunnels. HTTP is not constrained to using TCP/IP and its supporting layers, although this is its most popular application on the Internet.

Private Key Cryptography, also known as asymmetric cryptography, is a form of cryptography in which the key used to encrypt a message differs from the key used to decrypt it. In public key cryptography, a user has a pair of cryptographic keys—a public key and a private key. The private key is kept secret, while the public key may be widely distributed. Incoming messages would have been encrypted with the recipient's public key and can only be decrypted with his corresponding private key. The keys are related mathematically, but the private key cannot be practically derived from the public key.

A Public Key Certificate (or identity certificate) is an electronic document which incorporates a digital signature to bind together a public key with an identity information such as the name of a person or an organization, their location, and so forth. The certificate can be used to verify that a public key belongs to a particular component.

Secret Key Cryptography, also known as symmetric cryptography, uses a single secret key for both encryption and decryption. To use symmetric cryptography for communication, both the sender and receiver would have to know the key beforehand, or it would have to be sent along with the message.

A Web Server is a computer housing a computer program that is responsible for accepting HTTP requests from web clients, which are known as web browsers, and serving them HTTP responses along with optional data contents, which usually are web pages such as HTML documents and linked objects (images, etc.).

SOAP (Simple Object Access Protocol) is an XML-based protocol for exchanging information between computers.

A Web Service is a software system designed to support interoperable machine-to-machine interaction over a network. Web services are frequently Web application program interfaces that can be accessed over a network, such as the Internet, and executed on a remote system hosting the requested services.

XML or extensible market language is non-operating specific programming language. XML is a general-purpose specification for creating custom markup languages.

XML-RPC is a protocol that uses XML messages to perform Remote Procedure Calls. Requests are encoded in XML and sent via HTTP. XML responses are imbedded in the body of the HTTP response.

### DETAILED DESCRIPTION OF EMBODIMENTS

Exemplary embodiments of methods and systems for digital asset management according to the present invention are hereafter described. The present invention is described by way of reference to the management of assets associated with digital cinemas. While many of the embodiments that follow use the vernacular associated with digital cinemas, one skilled in the art will recognize that the scope of the present invention is not limited to digital cinemas but is rather limited only by the claims that follow.

Generally speaking, embodiments of the present invention include systems and methods for managing attributes of components used in the distribution and display of digital content. Using these attributes the providers of digital content can securely and reliably distribute their content to specific display venues and more specifically to particular digital components within those venues. To accomplish this on an on-going basis, a robust, efficient and reliable system must exist to manage the attributes associated with a plurality of digital components located at a plurality of display complexes.

Specific embodiments of the present invention are hereafter described in detail with reference to the accompanying Figures. Like elements in the various Figures are identified by like reference numerals for consistency. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

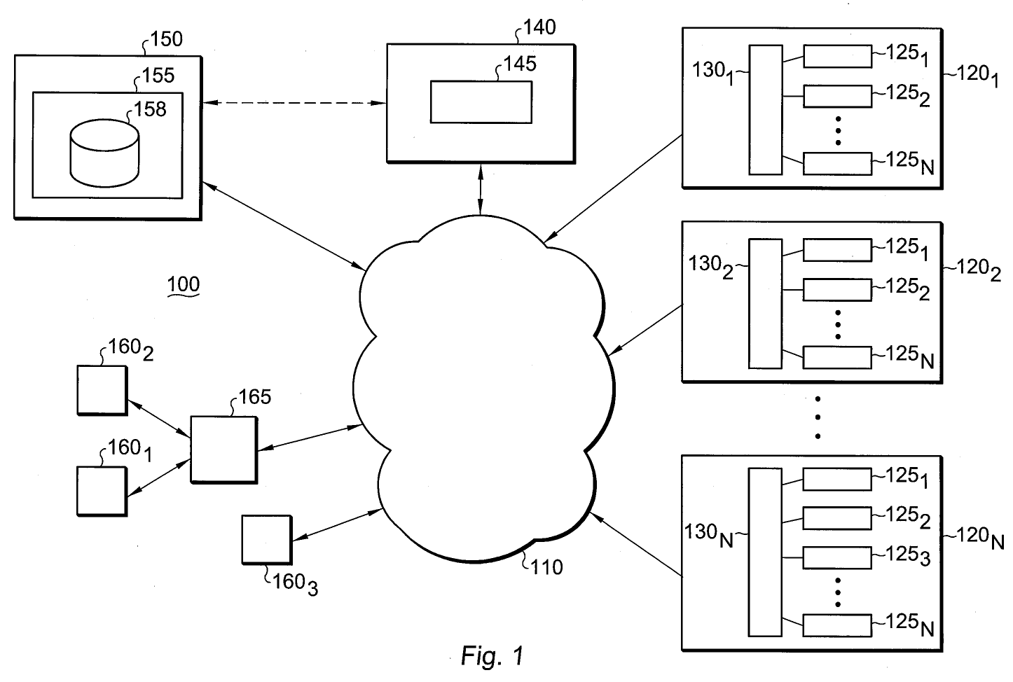

A high level block diagram illustrating a network architecture in which one embodiment of the present invention can be implemented is shown in FIG. 1. Components and modules of the asset management system 100 are communicatively coupled to a wide area network 110. As one skilled in the art will recognize, a wide area network can be the Internet or Intranet or other network configured to enable diverse communication of data among a variety of end points over diverse distances. The Internet is a collection of heterogeneous computers and networks coupled together by a web of interconnections using standardized communications protocols. The Internet is characterized by its vast reach as a result of its wide and increasing availability and easy access protocols. Internet protocols, routing mechanisms and address discovery mechanisms do not discriminate between users. Data packets are passed between routers and switches that make up the Internet based on the hardware's instantaneous view of the best path between source and destination nodes specified in the packet.

Coupled to the network 110 are a plurality of display complexes 120₁, 120₂, 120ₙ (collectively 120). Each display complex includes a plurality of digital components 125₁, 125₂, . . . 125ₙ (collectively 125) and a data collector 130₁, 130₂, . . . 130ₙ (collectively 130).

Also coupled to the wide area network 110 is a server 140. The server 140, according to one embodiment of the present invention, hosts a service module 145 configured to provide system services. The service module 145 provides system level services including web services, asset management services, and the like. A data repository 150 is also coupled to the wide area network 110 and includes an asset management module 155 and a persistent data storage medium 158. In another embodiment of the present invention, the data repository 150 is coupled to the server 140 via a direct link bypassing the wide area network 110. The storage medium can take many forms including tape, hard disc, flash, and any other medium capable of persistently storing data as would be known to one skilled in the relevant art. Likewise the asset management module can take the form of software and/or firmware and, according to one embodiment, reside in random access memory or read only memory of a computing device as appropriate. Indeed many of the modules of the asset management system can take the form of one or more modules of executable instructions embodied in the form of computer readable code. These program codes typically reside in a persistent memory source associated with a computer and/or processor and, upon loading into a random access memory source, are executed by a local processor.

Also coupled to the wide area network 110 are a plurality of clients 160₁, 160₂, . . . 160ₚ (collectively 160). Each client 160, according to one embodiment of the present invention, is coupled directly to the wide area network 110 and can accordingly communicate with the service module 145 hosted by the server 140. In another embodiment of the present invention, interposed between one or more clients 160 and the wide area network 110 is a content distributor 165. The distributor 165 acts as an intermediary for the clients 160 in the control and distribution of digital content.

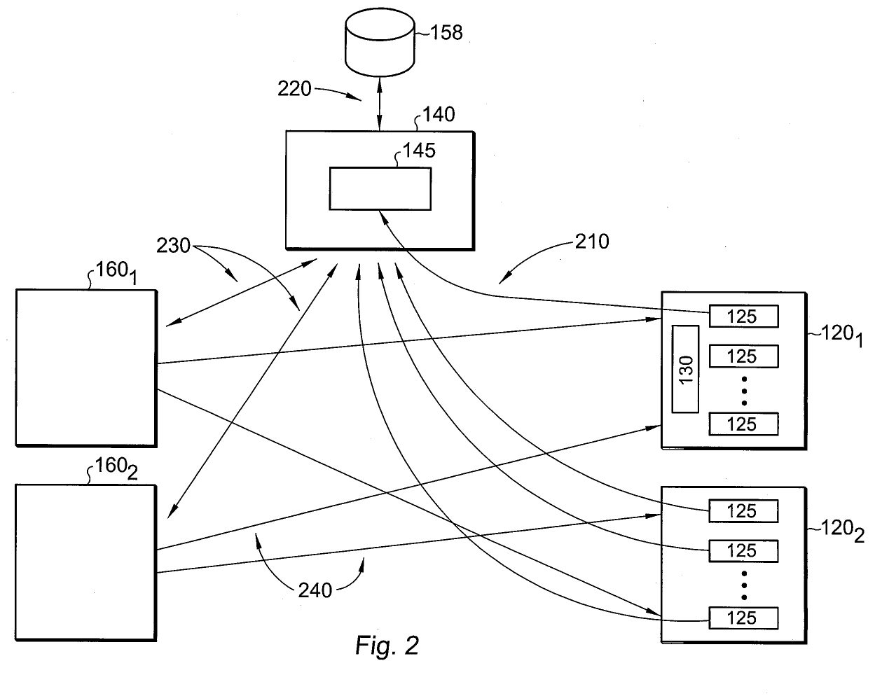

The asset management system 110 shown in FIG. 1 can be better understood by considering the flow of content and data between the clients 160 and the display complexes 120 shown in FIG. 2. As digital components 125 are installed and made operational in each of a plurality of display complexes 120, their status is communicated 210 to a service module 145 hosted by a server 140 via a wide area network (not shown). In the present context, each digital component 125 is a projector or projector system that is used to display digital content (movies, slides, or the like) on a display screen. In some implementations the digital component 125 may be a single piece of equipment capable of processing and projecting the content while in other implementations the system may comprise several components that receive, process, and project the content on a screen. Similarly a screen can include a liquid crystal display or a projection device utilizing light emitting diode technology. One skilled in the art will recognize the asset management system 100 of the present invention encompasses these and other implementation schemes for managing attributes of digital media including digital cinema systems.

Turning once again to FIG. 2, it can be appreciated that information is conveyed 210 from the display complexes 120 to the service module. In one embodiment attributes of each digital component 125 are amassed by a data collector 130 and conveyed to the service module 145 periodically. In other embodiments the digital components connect directly to the service module 145 for the conveyance of information.

The service module 145, hosted on a server 140 coupled to a wide area network 110, is designed to support machine-to-machine interaction over a network. The display complexes (via the data collector 130 or the individual digital components 125) access an application program interface (“API”) to access the requested service. In this case the requested service is set up to accept and manage attributes of a plurality of digital components 125. Such communications are typically conducted using XML since by using XML the service modules are not tied to any one operating system or programming language. For example a Java program can talk to a Perl program or a Windows program can talk to a Unix application.

The present invention utilizes service communication styles as are known to one skilled in the art. The service module utilizes a variety of implementation means including remote procedure calls, service-oriented architecture, and a representational state transfer. A remote procedure call is a distributed function call interface using SOAP. A service-oriented architecture is one in which the message is the basic unit of communication rather then an operation. In this approach as opposed to RPC, the service module relies on a loose coupling because the focus is more on the provider/client contract provided by the service module description language than the underlying implementation details.

Representational state transfer is also referred to as Restful web services. This is an attempt to emulate HTTP and similar protocols by constraining the interface to a set of well-known or standard operations. This process focuses on the state of the resources rather than the message or operation.

Embodiments of the present invention use an agent-less protocol to transfer data to the repository via a service module. Rather than having an agent resident at the display complexes that interacts with the service module, the present invention broadcasts information to the service module which then simply acknowledges to the display complex that the message has been received. The present invention implements a push system of data transfer rather than the traditional pull system.

In a traditional data storage system, a web service or similar interface would query the data source, in this case the display complexes, for data. Thus the service would pull information from the display complexes and then convey it 220 to the repository. In contrast, and according to one embodiment of the present invention, the service module does not pull information from the display complexes or the digital components. Rather the service module is passive with respect to when data is received. The display complexes contact the service module periodically and upload data. With the exception of a message back to the sending entity indicating that the message containing data has been received to prevent continual transmissions, no communication from the service module to the sending entity is necessary.

Referring again to FIG. 2, it can be seen that attributes of each digital component 125 are periodically pushed to the server 140 based service module 145. These attributes include component type, serial number, location, network address, public certificate, and public key. Once the data arrives at the service module, it is conveyed 220 to the repository for storage on a persistent storage medium 158.

According to one embodiment of the present invention, the data can be stored in a relational database such that retrieval can be based on one or more of the attribute associations. Thus while each digital component 125 may have associated with it several attributes such as serial number, public certificate, location, etc., each of these attributes can be used as the basis for an inquiry.

In addition to storing the component attribute information upon its initial arrival, the asset management module 155 also identifies changes to the information contained within the repository. As data arrives at the repository, it is stored based on its association with a specific display complex auditorium. When a component attribute associated with a particular display complex auditorium changes, the asset control module generates a signal to a system administrator that the repository has been altered. Normally once a component or component system has been established in an auditorium, changes to the digital component/system would not be expected. However, components must be repaired or replaced for a variety of reasons and the asset management system tracks such changes to insure that the repository possesses the most accurate data possible with respect to each auditorium within the system. Thus should a change in any attribute occur, the repository is immediately updated. To insure accuracy, however, a signal is presented to a system administrator for further scrutiny. In addition, and according to another embodiment of the present invention, a record of all modifications to the repository is maintained until the changes are verified. In this manner should an attribute change occur in error, the repository can be restored to its previous, correct status.

As the number of display complexes 120 grows, and with them the number of digital components 125, so, too, does the attribute repository 158. To distribute content to an auditorium from a client 160 for viewing, a client 160 must possess the public certificate and public key of the components associated with that auditorium. As was previously described, it is desirable to efficiently and reliably distribute digital content to an auditorium in a secure manner.

One means of securely delivering content to a particular digital component is to encrypt that content using that component's public key. Once encrypted, the content can only be decrypted by that component's private key. This type of message encryption is well known to those skilled in the relevant art and is not the subject of the present invention. An alternative method of secure transfer can be accomplished by once again using a component's public key; but rather than using the public key to encrypt the content, it is used to encrypt a newly generated client private key. The encrypted private key is transmitted 240 to the digital component that uses its private key to decrypt the message. Upon decryption, the digital component 125 possesses the newly generated private key of the client 160. Following in a separate transmission is content encrypted using the public key pair of the client's private key. Using the new private key the digital component can decrypt the content for display.

Both methods are secure means by which to convey digital content. The latter technique provides an extra layer of security in that the key used to decrypt the content is newly generated and travels separate from the content. Both techniques, however, require the public key of the digital component.

To gain the public key of a particular component associated with a specific display complex, the client 160 sends a request 230 for a particular key or public certificate to the service module 145. The service module 145 authenticates the client 160 and passes the request for the key (or certificate) to the asset management module. The asset management module determines whether the client has authorization to retrieve the requested attribute. When authorization exists, the requested attribute is retrieved from the repository and conveyed 230 back to the client 160. If the client 160 does not possess authorization to view an attribute, a message is sent back to the client rejecting the request. Authorization to view attributes such as keys, serial number of components, and so forth is based on contractual arrangements between the client and the display complexes. Periodically the display complexes and the clients update the asset management module with current relationships between clients and display complexes.

Responsive to the authenticated client having the authority to view an attribute, the attribute is retrieved from the repository and conveyed 230 to the client 160. Once in possession of the client 160, the client uses the information to encrypt the content or a key and transmit the information directly to the display complex/digital component. Encrypted content is targeted specifically for a digital component. In other embodiments of the present invention, the display complex may possess and store in the repository a complex public key. Using this display complex key, clients can convey digital content securely to the display complex which can then distribute it to a plurality of client systems within that complex.

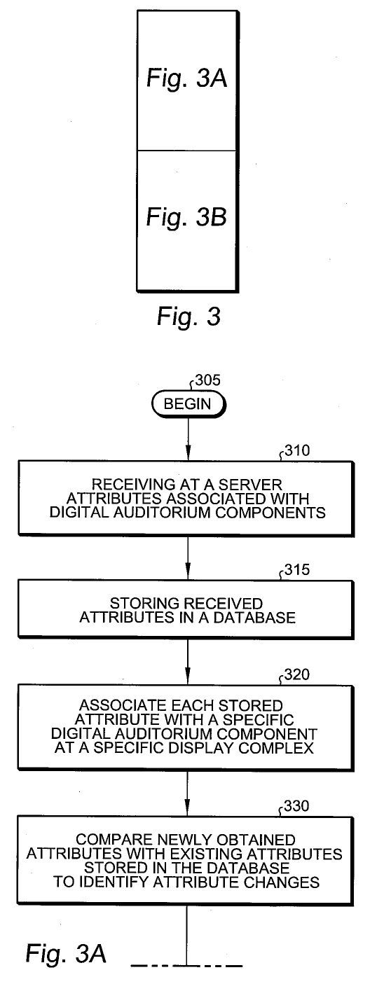

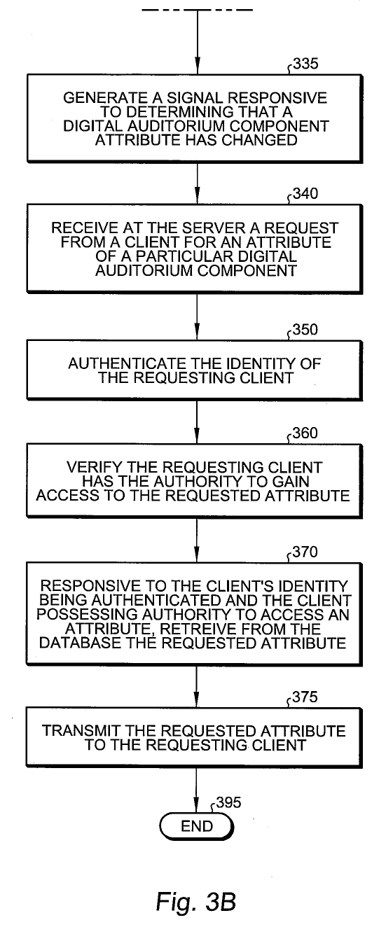

FIG. 3 is a flowchart illustrating methods of implementing an exemplary process managing digital assets. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

The asset management process begins 305 by a server receiving 310 attributes associated with digital components located at a plurality of display complexes. According to one embodiment of the present invention, the attributes are extracted directly from components and collected by the display complex prior to being periodically transmitted to the server. In other embodiments of the present invention, changes in the attributes are recognized by the display complex and are immediately pushed to the server to ensure that the data repository possesses timely and accurate data.

Upon receiving attribute data from a plurality of digital components, the server conveys the data to a repository where it is stored 315 in a persistent storage medium. Concurrently with the storage process, or shortly thereafter, the each asset attribute is associated 320 with a specific digital component in a specific display complex. As new information arrives and as new entries in the repository are created, an asset management module compares 330 newly arrived attribute information with data already resident in the repository to identify any specific attribute modification or change.

Responsive to a change being identified, the asset management module generates 335 a signal directed to a system administrator or similar entity that an attribute change has occurred. The system administrator can then act to verify the change with the display complex to ensure the information is accurate.

While the verification process is underway, the repository remains accessible to a plurality of clients seeking information about components so as to distribute and display digital content. When a client wishes to convey digital content for a display complex for display by a specific digital component, the client must gain the public key and/or location (network address) of the component. A request is generated by the client and received 340 by the server for attribute information about a particular digital component. For example the request can be for the component's public certificate and public key as well as the network address for the display complex at which the digital component is resident.

Upon receipt, the service module hosted by the server authenticates 350 the client's identity and verifies 360 that the client has the authority to access the requested attribute. In another embodiment of the present invention, the asset management module at the repository verifies the client's authority.

Responsive to the client having been authenticated and the client possessing the proper requisites to access data housed in the repository, the requested data is retrieved 370 from the repository and conveyed to the server. Thereafter the data is transmitted 375 to the requesting client for use in distributing its digital content. Alternatively the asset management module, once determining that the client's request is authentic and authorized, can convey the data directly to the client via a wide area network.

The asset management system of the present invention enables one or more clients to access attributes from a plurality of digital components. Using this information the clients can convey secure digital content directly to a digital component for display within that auditorium. The repository of the attributes comprises a relational database that is coupled to a service module hosted on a server coupled to a wide area network. Digital component attribute data is periodically pushed from the plurality of display complexes to ensure that the repository of component attributes is reliably current.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

In preferred embodiments, the present invention is implemented in software. Software programming code that embodies the present invention is typically accessed by the microprocessor from long-term storage media of some type, such as a CD-ROM drive or hard drive. The software programming code may be embodied on any of a variety of known media for use with a data processing system, such as a diskette, hard drive, or CD-ROM. The code may be distributed on such media, or may be distributed from the memory or storage of one computer system over a network of some type to other computer systems for use by such other systems. Alternatively, the programming code may be embodied in the memory and accessed by the microprocessor. The techniques and methods for embodying software programming code in memory or on physical media and/or distributing software code via networks are well known and will not be further discussed herein.

The display complexes and/or the clients may connect to the server using a wireline connection, or a wireless connection. (Alternatively, the present invention may be used in a standalone mode without having a network connection.) Wireline connections are those that use physical media such as cables and telephone lines, whereas wireless connections use media such as satellite links, radio frequency waves, and infrared waves. Many connection techniques can be used with these various media, such as: using the computer's modem to establish a connection over a telephone line, using a LAN card such as Token Ring or Ethernet, using a cellular modem to establish a wireless connection, etc. The user's computer may be any type of computer processor, including laptop, handheld or mobile computers, vehicle-mounted devices, desktop computers, mainframe computers, etc., having processing capabilities (and communication capabilities when the device is network-connected). The server, similarly, can be one of any number of different types of computers that have processing and communication capabilities. These techniques are well known in the art, and the hardware devices and software which enable their use are readily available.

When implemented in software, the present invention may be implemented as one or more computer software programs. The present invention may also be executed in a Web environment where software installation packages are downloaded using a protocol such as the HTTP from a Web server to one or more target computers that are connected through the Internet. Alternatively, an implementation of the present invention may be executing in other non-Web networking environments (using the Internet, a corporate intranet or extranet, or any other network) where software packages are distributed for installation using other techniques. Configurations for the environment include a client/server network, as well as a multi-tier environment. Or, as stated above, the present invention may be used in a standalone environment, such as by an installer who wishes to install a software package from a locally-available installation media rather than across a network connection. Furthermore, it may happen that the client and server of a particular installation both reside in the same physical device, in which case a network connection is not required. (Thus, a potential target system being interrogated may be the local device on which an implementation of the present invention is implemented.) A software developer or software installer who prepares a software package for installation using the present invention may use a network-connected workstation, a standalone workstation, or any other similar computing device. These environments and configurations are well known in the art.

The target devices (client or display complexes) with which the present invention may be used advantageously include end-user workstations, mainframes or servers on which software is to be loaded, or any other type of device having computing or processing capabilities (including “smart” appliances in the home, cellular phones, personal digital assistants or “PDAs”, dashboard devices in vehicles, etc.).

While there have been described above the principles of the present invention in conjunction with an asset management system for the distribution of digital content, it is to be clearly understood that the foregoing description is made only by way of example and not as a limitation to the scope of the invention. Particularly, it is recognized that the teachings of the foregoing disclosure will suggest other modifications to those persons skilled in the relevant art. For example, while digital content attributes have been described as being retained in a repository, the repository may comprise multiple storage media types distributed over a network such as in a storage area network or the like. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

We claim:

1. A method for managing asset attributes of a plurality of digital components, the method comprising:
receiving at a server asset attributes corresponding to each of the plurality of digital components;
storing received asset attributes for each of the plurality of digital components in an asset attribute repository wherein each asset attribute is associated with its corresponding digital component;
identifying changes in the asset attribute repository;
receiving a request from a client for an asset attribute associated with at least one digital component; and
transmitting the asset attribute to the client in response to the request.

2. The method of claim 1 further comprising extracting asset attributes directly from each of the plurality of digital components.

3. The method of claim 1 wherein said asset attributes includes a public certificate associated with said digital component.

4. The method of claim 1 wherein each of the plurality of digital components is associated with one display complex.

5. The method of claim 4 wherein the one or more display complexes collect asset attributes associated with digital components resident at the one or more theaters.

6. The method of claim 5 wherein the one or more display complexes periodically transmit asset attributes to the server.

7. The method of claim 6 wherein the server passively receives from said one or more display complexes.

8. The method of claim 1 wherein the server is communicatively coupled to a wide area network.

9. The method of claim 1 wherein the server hosts a service.

10. The method of claim 1 further comprising maintaining a record of changes to the asset attribute repository.

11. The method of claim 1 wherein the request is received at the server by a service module.

12. The method of claim 11 wherein the service module queries the asset attribute repository based on the request and responsive to the asset attribute repository possessing the requested asset attribute, conveying the asset attribute to the service module.

13. A digital asset management system, the system comprising:
a plurality of display complexes wherein each display complex includes one or more digital components, each digital component having a plurality of component attributes;
a server coupled to a wide area network configured to receive data from the plurality of display complexes;
a repository communicatively coupled to the server configured to store said data; and
one or more clients communicatively coupled to the wide area network and configured to initiate requests to the server for data stored in the repository.

14. The system of claim 13 wherein said display complex is configured to collect digital component attributes from the one or more digital components and communicate said collected digital component attributes to said server.

15. The system of claim 13 wherein said one or more digital components includes a projector system configured to project digital images.

16. The system of claim 13 wherein said plurality of component attributes includes a digital certificate.

17. The system of claim 16 wherein the digital certificate includes a public key.

18. The system of claim 13 wherein the server hosts a service.

19. The system of claim 13 wherein received data includes the plurality of component attributes associated with each digital component.

20. The system of claim 19 wherein the repository is configured to associate each component attribute with a unique digital component of one of the plurality of display complexes.

21. The system of claim 19 wherein the repository configured to compare component attributes associated with each digital component received from the server with stored component attributes associated with each digital component to determine whether a change has occurred.

22. The system of claim 21 wherein the repository is configured to record all component attribute changes.

23. A computer-readable storage medium tangibly embodying a program of instructions executable by a machine wherein said program of instructions comprises a plurality of program codes for digital asset management, said program of instructions comprising:
program codes for receiving at a server asset attributes corresponding to each of the plurality of digital components;
program codes for storing received asset attributes for each of the plurality of digital components in an asset attribute repository wherein each asset attribute is associated with its corresponding digital component;
program codes for identifying changes in the asset attribute repository;
program codes for receiving from a client a request for an asset attribute associated with at least one digital component; and
program codes for transmitting the asset attribute to the client in response to the request.

24. The computer-readable storage medium of claim 23 further comprising program codes for extracting asset attributes directly from each of the plurality of digital components.

25. The computer-readable storage medium of claim 23 wherein said asset attributes include a public certificate having a public key associated with said digital component.

26. The computer-readable storage medium of claim 23 wherein the plurality of digital components is associated with one or more display complexes and wherein the one or more display complexes collect asset attributes associated with each digital component resident at the one or more display complexes.

27. The computer-readable storage medium of claim 23 further comprising program codes at the server for hosting a service.

28. The computer-readable storage medium of claim 23 further comprising program codes for maintaining a record of changes to the asset attribute repository.

29. The computer-readable storage medium of claim 23 further comprising program codes conveying the requested asset attribute from the asset attribute repository to the client via a service module.
